(19) United States
(12) Patent Application Publication
(10) Pub. No.: US 2015/0054574 A1
(43) Pub. Date: Feb. 26, 2015

(54) DIGITAL CONTROL SYSTEM FOR DISTRIBUTED VOLTAGE REGULATORS

(71) Applicant: International Business Machines Corporation, Armonk, NY (US)

(72) Inventors: John F. Bulzacchelli, Yonkers, NY (US); Paul D. Muench, Poughkeepsie, NY (US); Michael A. Sperling, Poughkeepsie, NY (US); Zeynep Toprak Deniz, Norwalk, CT (US)

(73) Assignee: International Business Machines Corporation, Armonk, NY (US)

(21) Appl. No.: 13/974,130

(22) Filed: Aug. 23, 2013

(51) Int. Cl. G05F 1/46

(52) U.S. Cl. CPC G05F 1/468
USPC 327/540

(57) ABSTRACT

A system and method to regulate voltage on a chip are described. The system includes a central controller to output a digital code based on a voltage measurement from a sense point on a power grid of the chip. The system also includes a plurality of micro-regulators, each of the plurality of micro-regulators outputting a respective voltage to the power grid based on the digital code.

### BACKGROUND

The present invention relates to scalable regulation circuitry, and more specifically, to on-chip voltage regulation. A voltage regulator maintains a constant output voltage level even as load current or input voltage changes. One application for voltage regulators is for logic circuit power supplies on integrated circuits or chips. A previous approach has been to perform voltage regulation outside the chip itself. However, this may result in slower response to on-chip noise as well as expensive regulation components. Previous on-chip regulation techniques have suffered from load sharing inequalities among the various regulators, setpoint inaccuracies, susceptibility to noise coupling, or issues with power efficiency that affect scalability.

### SUMMARY

According to one embodiment of the present invention, a voltage regulation system on a chip includes a central controller configured to output a digital code based on a voltage measurement from a sense point on a power grid of the chip; and a plurality of micro-regulators, each of the plurality of micro-regulators being configured to output a respective voltage to the power grid based on the digital code.

According to yet another embodiment, a voltage regulator to maintain an average voltage of a power grid on a chip includes a differential amplifier configured to amplify a difference between a voltage measurement from the power grid of the chip and a reference voltage; and an analog-to-digital converter configured to provide a digital code to a plurality of micro-regulators to control the average voltage of the power grid based on the difference.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a chip including a voltage regulation system according to embodiments of the invention;

FIG. 2 further details the central controller shown in FIG. 1;

FIG. 3 illustrates the generation of exemplary digital codes according to embodiments of the invention;

FIG. 4 further details a micro-regulator shown in FIG. 1;

FIG. 5 further details the micro-regulator shown in FIG. 4; and

FIG. 6 is a process flow of a method of controlling the voltage supplied to load circuitry on a chip according to an embodiment of the invention.

### DETAILED DESCRIPTION

As noted above, a voltage regulation circuit provides a desired output voltage regardless of changes in load current or input voltage. On-chip circuitry, such as complementary metal-oxide-semiconductor (CMOS) logic, can be prone to sudden and extreme variations in load current. This is because the current drawn by CMOS logic can be dynamic rather than static such that the load current presented to the voltage regulation circuit changes from a minimum to a maximum rapidly when the CMOS logic switches from an idle state to a state with a maximum workload. Having an off-chip voltage regulation circuit has proved problematic with regard to the speed of the response, for example. Previous on-chip voltage regulation solutions have presented scalability issues. For example, an on-chip voltage regulator that provides analog up/down signals to distributed micro-regulators requires a dedicated pair of wires to carry up/down currents from the central regulator to each micro-regulator. In a large digital system (e.g., requiring 40 or more micro-regulators), the number of dedicated point-to-point wires becomes infeasible. In addition, the wires that carry the analog currents to each of the micro-regulators must be custom-routed with shielding. Embodiments of the system and method described herein relate to on-chip voltage regulation that includes a digital code provided to each micro-regulator from a central on-chip regulator controller.

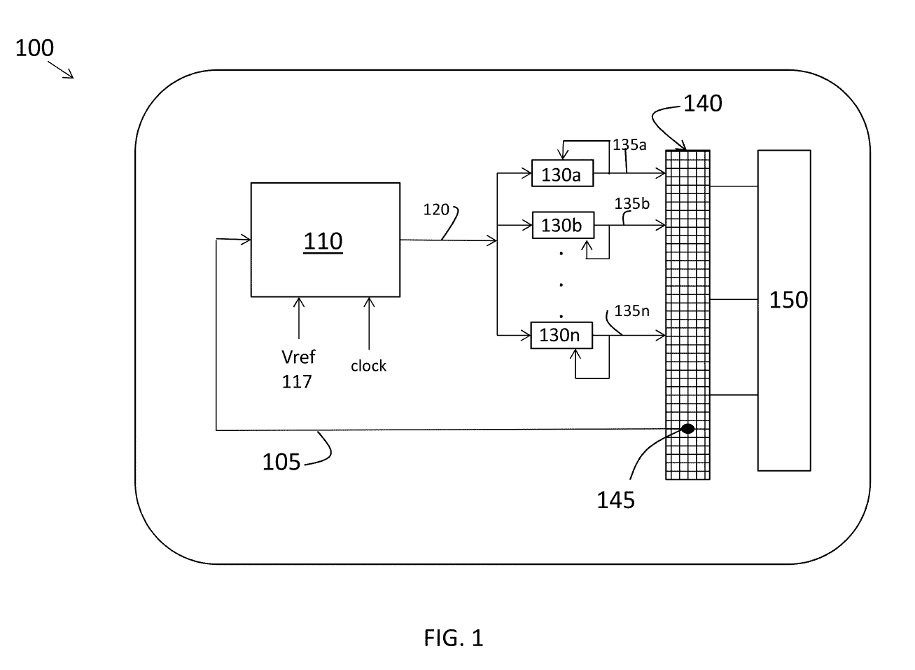

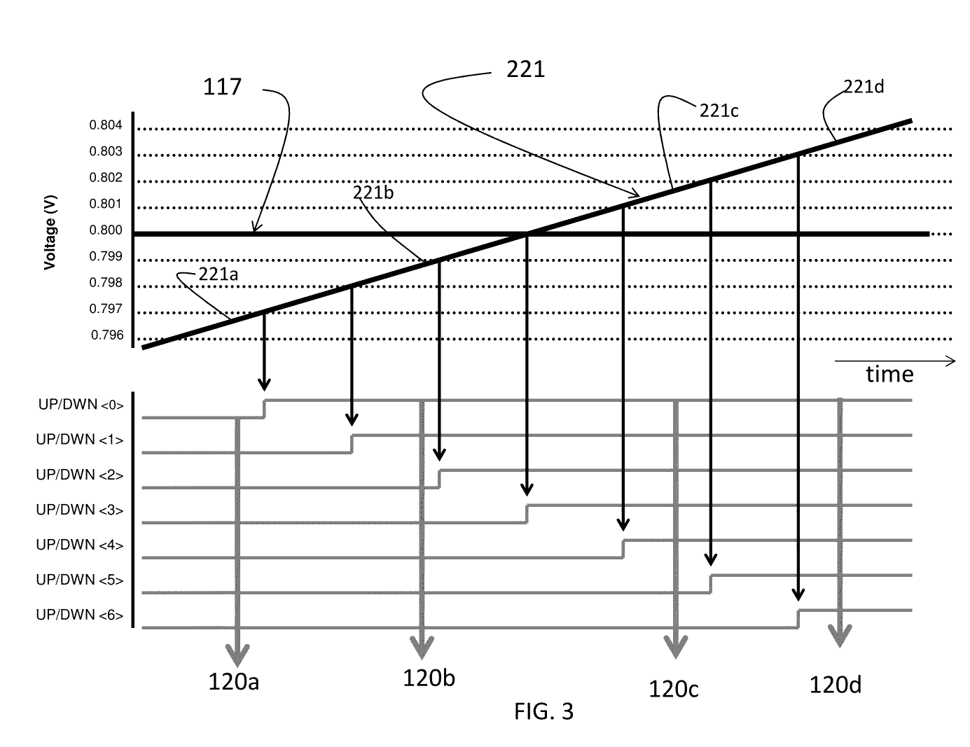

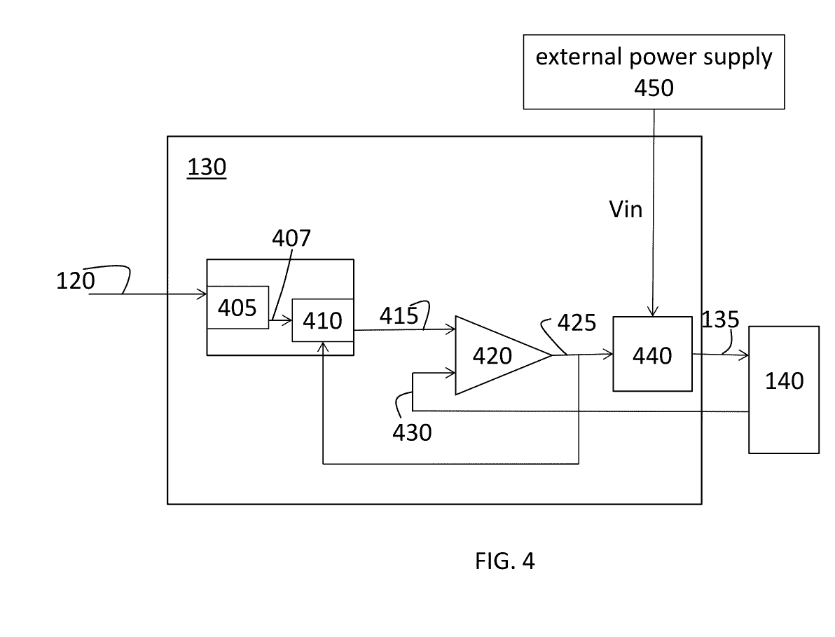

FIG. 1 is a block diagram of a chip 100 including a voltage regulation system according to embodiments of the invention. The voltage regulation system includes a central controller 110 and a plurality of micro-regulators 130a-130n (collectively or generically 130) that supply the grid 140 from which load circuitry 150 draws power on the chip 100. As detailed below, the voltage regulation system according to embodiments described herein includes a scalable outer control loop that maintains an average voltage at a location (sense point 145) on the power grid 140. The scalability of the outer control loop is facilitated by the central controller 110 outputting a digital code 120 (rather than currents, for example) that can be sent over long distances across the chip 100 with less degradation than a comparable analog signal. The voltage regulation system also includes a relatively faster inner control loop within each micro-regulator 130 to control the regulated voltage local to each micro-regulator 130. The digital code 120 output by the central controller 110 may be, for example, an n-bit thermometer coded (unary) signal. In alternate embodiments, the digital code 120 may be a single bit. In the exemplary case shown in FIG. 3, a seven-bit digital code 120 is output to each of the micro-regulators 130a-130n. Each of the micro-regulators 130 adjusts its individual micro-regulator output voltage 135 to the grid 140 that supplies load circuitry 150 based on the digital code 120 from the central controller 110. The digital code 120 generates an input for the inner control loop within each micro-regulator 130. The digital code 120 indicates an up or down (increase or decrease) of the charge pump 410 (FIG. 4) within each of the micro-regulators 130. The central controller 110 generates each digital code 120 based on receiving a sense point voltage 105 from a sense point 145 on the power grid 140 and comparing it with a reference voltage 117.

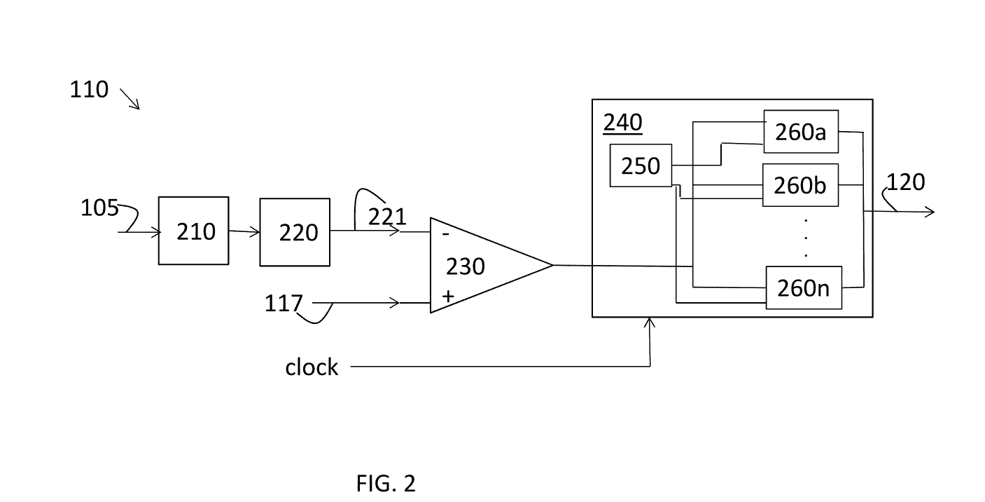

FIG. 2 further details the central controller 110 shown in FIG. 1. As noted above, the central controller 110 maintains an average voltage at the sense point 145 that it monitors on the grid 140. The central controller 110 maintains the average voltage by outputting digital codes 120 to the plurality of micro-regulators 130. The central controller 110 may output the digital codes 120 periodically or based on an event trigger, for example. An input to the central controller 110 is the sense point voltage 105. The central controller 110 may include an anti-aliasing filter 210 before a sample-and-hold circuit 220 to attenuate the high-frequency ripple of the sense point voltage 105 and ensure an accurate sample of the sense point voltage 105 (free from aliasing). The processed grid voltage 221 output from the sample-and-hold circuit 220 is compared with the reference voltage 117 (desired grid 140 voltage) using a differential amplifier 230. Thus, the output of the differential amplifier 230 represents the correction (up/down) needed for the grid 140 voltage, which is represented by the digital code 120. The digital code 120 is output based on the differential amplifier 230 output using, for example, a flash analog-to-digital converter (ADC) 240. The ADC 240 may include a level generator 250 and a plurality of voltage comparators 260a-260n (collectively or generically 260) to output the digital code 120 as, for example, a thermometer coded signal. While the digital code 120 is contemplated to include any type of digital code, the digital code 120 being a unary thermometer coded signal (rather than a binary code, for example) may simplify digital-to-analog conversion of the digital code 120 at the micro-regulators 130 using thermometer digital-to-analog converters (DACs) (that drive the charge pump 410, FIG. 4) at the micro-regulators 130. For example, if the digital bits of the digital code 120 are not re-latched (retimed to a local clock), there may be signal skew among the digital bits, and a small change in a binary code from 0111 to 1000 may be misread as 1111 by a micro-regulator 130. This type of false code reading may be avoided by using a thermometer coded signal as the digital code 120 output by the central controller 110 and thermometer DACs as the DACs (405, FIG. 4) in the micro-regulators 130, because a thermometer DAC has a corresponding resistor or current-source segment for each possible DAC output value.

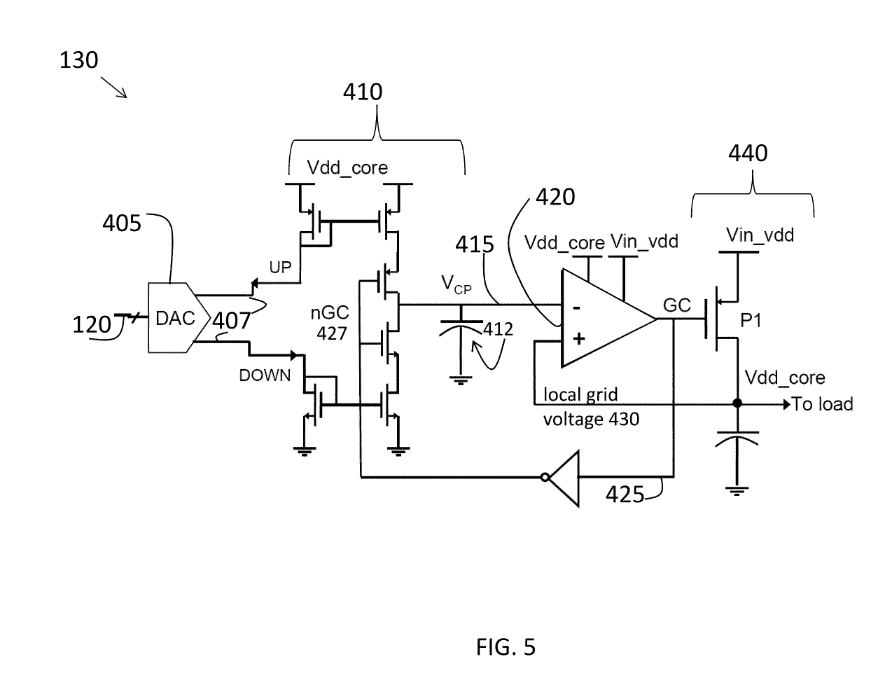

FIG. 3 illustrates the generation of exemplary digital codes 120 according to embodiments of the invention. The (constant) desired reference voltage 117 is shown in the example as 0.8 volts (V). The sense point voltage 105 (processed grid voltage 221 after processing by the anti-aliasing filter 210 and sample-and-hold circuit 220), as shown in FIG. 3, increases from a voltage value that is less than the reference voltage 117 to a voltage value that is greater than the reference voltage 117. Four different digital codes 120a, 120b, 120c, 120d are highlighted and will be discussed in turn. Each of the exemplary digital codes 120 includes seven bits with a value of either 0 or 1. Each digital code 120 corresponds with a difference between the processed grid voltage 221 and the reference voltage 117 and is proportional to the difference, as illustrated by the example. The digital code 120a corresponds with a processed grid voltage 221a and the constant reference voltage 117. Because the processed grid voltage 221a is less than the reference voltage 117, the digital code 120a indicating an “up” correction is output by the central controller 110 based on the differential amplifier 230 output. When all seven bits of a digital code 120 are 0 (as is the case for digital code 120a), this indicates a strong “up” correction. The digital code 120b corresponds with a processed grid voltage 221b and the constant reference voltage 117. Because the processed grid voltage 221b is less than the reference voltage 117 but not as low as processed grid voltage 221a, the digital code 120b, which still indicates an “up” but to a smaller degree, is output by the central controller 110 in this case. That is, because the digital code 120 is proportional to the difference between the processed grid voltage 221 and the reference voltage 117 and because that difference is smaller in the case of processed grid voltage 221b compared with processed grid voltage 221a, the digital code 120b may be 1100000 as shown in FIG. 3. While the digital code 120b, like 120a, still indicates an “up” because it includes more 0s than 1s, the digital code 120b effects a slower rate of change for the charge pumps 410 (FIGS. 4 and 5) of the micro-regulators 130 than digital code 120a, as detailed with reference to FIG. 5. The digital code 120c corresponds with a processed grid voltage 221c and the constant reference voltage 117, and the digital code 120d corresponds with a processed grid voltage 221d and the constant reference voltage 117. Both processed grid voltages 221c and 221d are greater than the reference voltage 117 and, therefore, both digital codes 120c and 120d indicate “down.” However, the processed grid voltage 221d is greater than the reference voltage 117 by a larger margin than the processed grid voltage 221c. Thus, the digital code 120c (1111100), while indicating a “down” correction like the digital code 120d (1111111), effects a slower rate of change in the charge pump 410 of each micro-regulator 130.

FIG. 4 further details a micro-regulator 130 shown in FIG. 1. Each micro-regulator 130 includes a DAC 405 and a charge pump 410, which are further detailed in FIG. 5. The DAC 405, which may be a thermometer DAC as discussed above, converts the digital code 120 from the central controller 110 to analog up/down signals (e.g., currents) 407. These up/down signals 407 control the charge pump 410 to increase or decrease an internal reference voltage 415 for the micro-regulator 130. The internal reference voltage 415 is compared with a local grid voltage 430 by a comparator 420. The local grid voltage 430 is local to the part of the grid 140 where the particular micro-regulator 130 is located. The comparator 420 output 425 is fed back to the charge pump 410 where it switches the up/down signals 407 (currents) applied to the charge pump. The comparator 420 output 425 is also used to control the output device 440 of the micro-regulator 130. The output device 440 is, for example, a p-channel field effect transistor (pFET) that also has an input from an external power supply 450 and outputs the micro-regulator output voltage 135 to the grid 140. As described above, the central controller 110 maintains an average voltage on the grid 140 through a relatively slower outer loop control while each micro-regulator 130 performs a relatively faster local voltage control. By having both global (through the central controller 110) and local (within each micro-regulator 130) control of each micro-regulator 130, load sharing among the micro-regulators 130 is achieved as detailed below.

FIG. 5 further details the micro-regulator 130 shown in FIG. 4. The digital code 120 from the central controller 110 is received by each of the micro-regulators 130 and converted by the digital-to-analog converter 405 into up/down currents (up/down signals 407). In addition to the up/down signals 407 based on the digital code 120, another input to the charge pump 410 of each micro-regulator 130 is the output 425 of the comparator 420. This output 425 is inverted to generate a signal 427 (nGC) which has a polarity such that the charge pump 410 capacitor 412 is charged upward when the output device 440 (e.g., pFET) is off and charged downward when the output device 440 is on. When the duty cycle of the output device 440 conduction is D, the charge pump 410 equilibrium is achieved when:

$$\frac{up}{down} = \frac{D}{1 - D} \qquad [ EQ . 1 ]$$

EQ. 1 indicates how load sharing is achieved among the plurality of micro-regulators 130 that are controlled by the central controller 110. Because every micro-regulator 130 generates the same up and down currents (up/down signals 407 based on the common digital code 120), EQ. 1 cannot be satisfied unless all of the micro-regulators 130 operate with the same duty cycle (D). If some of the micro-regulators 130 were operating with higher duty cycles than others and were providing more current to the power grid than others, the resulting load sharing imbalance could not persist based on the common digital code 120 received by all of the micro-regulators 130. Through the outer loop control of the central controller 110 and the digital code 120, the charge pump 410 voltages (V_{CP}) in the different micro-regulators 130 would be readjusted and the duty cycles (D) driven back to equality (among all the micro-regulators 130). The duty cycles (D) for all the micro-regulators 130 may be driven back to equality in less than 1 microsecond, for example.

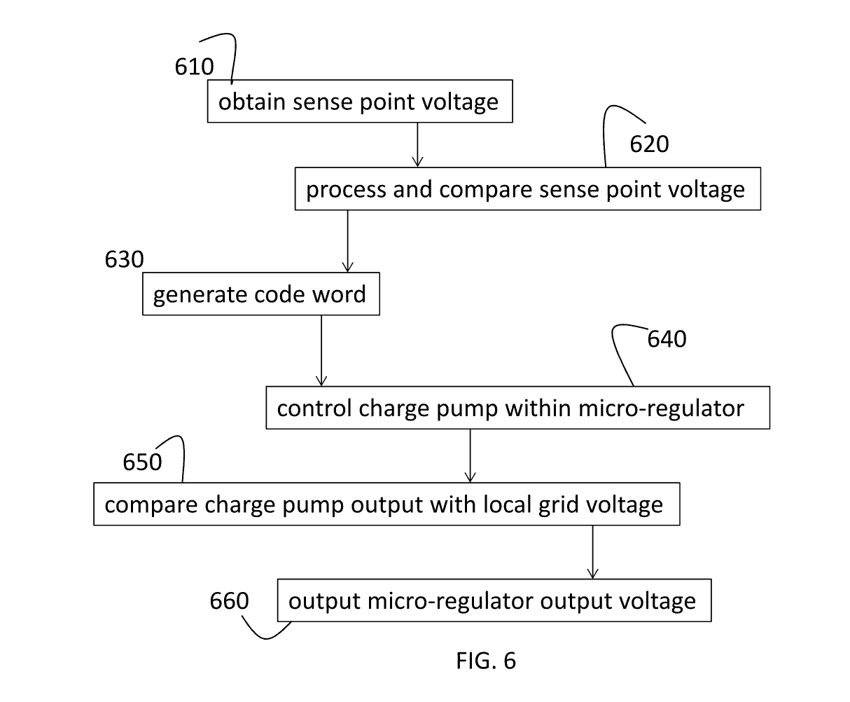

FIG. 6 is a process flow of a method of controlling the voltage supplied to load circuitry 150 on a chip 100 according to an embodiment of the invention. At block 610, obtaining sense point voltage 105 includes the central controller 110 receiving the sense point voltage 105 measurement from a sense point 145 on the grid 140. Processing and comparing the sense point voltage 105 at block 620 includes generating the processed grid voltage 221 and comparing it with the reference voltage 117 using the differential amplifier 230. At block 630, generating the digital code 120 includes using the ADC 240 on the differential amplifier 230 output. At block 640, controlling the charge pump 410 includes converting the digital code 120 to analog up/down signals in each micro-regulator 130. Blocks 610 through 640 represent the outer control loop implemented with the central controller 110. The inner control loop within each micro-regulator 130 includes comparing the internal reference voltage 415 resulting from the digital code 120 with a local grid voltage 430 at block 650. At block 660, outputting the micro-regulator output voltage 135 includes controlling an output device 440 of the micro-regulator 130 using the comparator 420 output 425. Blocks 650 and 660 represent an inner control loop implemented within each micro-regulator 130 based on the digital code 120 output from the central controller 110 based on the outer control loop. The inner control loop (blocks 650 and 660) within each micro-regulator 130 is relatively faster compared with the outer control loop (blocks 610 through 640) involving the central controller 110.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagram depicted herein is just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A voltage regulation system on a chip, comprising:
a central controller configured to output a digital code based on a voltage measurement from a sense point on a power grid of the chip; and
a plurality of micro-regulators, each of the plurality of micro-regulators being configured to output a respective voltage to the power grid based on the digital code.

2. The system according to claim 1, wherein the central controller includes a differential amplifier to amplify a difference between the voltage measurement and a reference voltage, and the digital code provides an up or down indication based on whether the voltage measurement is less than or greater than the reference voltage, respectively.

3. The system according to claim 2, wherein the digital code represents a correction that is proportional to the difference.

4. The system according to claim 2, wherein the voltage measurement is filtered or sampled prior to being input to the differential amplifier.

5. The system according to claim 2, wherein the central controller generates the digital code as a binary code, a single bit, or a thermometer coded signal representing the differential amplifier output.

6. The system according to claim 1, wherein each of the plurality of micro-regulators generates a respective internal reference voltage based on the digital code.

7. The system according to claim 6, wherein each of the plurality of micro-regulators comprises a charge pump configured to generate the respective internal reference voltage based on the digital code.

8. The system according to claim 6, wherein each of the plurality of micro-regulators compares the respective internal reference voltage with a respective local grid voltage to generate a respective comparator output and outputs the respective voltage to the power grid by controlling an output device with the respective comparator output.

9-16. (canceled)

17. A voltage regulator to maintain an average voltage of a power grid on a chip, the voltage regulator comprising:
a differential amplifier configured to amplify a difference between a voltage measurement from the power grid of the chip and a reference voltage; and
an analog-to-digital converter configured to provide a digital code to a plurality of micro-regulators to control the average voltage of the power grid based on the difference.

18. The voltage regulator according to claim 17, wherein the digital code comprises a binary code, a single bit, or a thermometer coded signal.

19. The voltage regulator according to claim 17, wherein each of the plurality of micro-regulators implements an inner control loop based on the digital code to output a voltage to the power grid.

20. The voltage regulator according to claim 19, wherein each of the plurality of micro-regulators includes a charge pump configured to output a respective internal reference voltage based on the digital code as an input to the inner control loop.
